(19) United States
(12) Patent Application Publication
(10) Pub. No.: US 2005/0251485 A1
(43) Pub. Date: Nov. 10, 2005

(54) Systems for soliciting donations

(76) Inventor: Daniel H. Quigley, Coxsackie, NY (US)

Correspondence Address: David A. Pascarella, Esq.;Heslin Rothenberg Farley & Mesiti P.C., 5 Columbia Circle, Albany, NY, 12203, US

(21) Appl. No.: 11/186,336

(22) Filed: Jul. 21, 2005

Related U.S. Application Data
(60) Provisional application No. 60/672,309, filed on Apr. 18, 2005.

(51) Int. Cl. G06F 17/30

(52) U.S. Cl. 705/53

(57) ABSTRACT

Systems are provided for managing and soliciting donations made during checkout of a plurality of online purchases at a plurality of online retailers by a plurality of online shoppers. In one embodiment, the system includes a processor for receiving, over a communications network, data regarding a plurality of amounts for donation and a plurality of selected organizations made during checkout of the plurality of online purchases at the plurality of online retailers by the plurality of online shoppers, and collecting a plurality of payments for the plurality of amounts for donation and distributing the plurality of payments among the plurality of organizations based on the data. The system may include the online shoppers being asked at the time of checkout if they would like to round-up their total purchase price to the nearest dollar and select a charity/nonprofit organization to donate the spare change.

### CROSS-REFERENCE TO RELATED APPLICATIONS

This application claims the benefit of U.S. Provisional Application No. 60/672,309, filed Apr. 18, 2005, entitled “ONLINE CHANGE ROUND UP DONATION SYSTEM”, which is hereby incorporated in its entirety herein by reference. This application is also related to U.S. patent application Ser. No. ______, filed concurrently herewith, and entitled “METHODS FOR SOLICITING DONATIONS”, which is hereby incorporated in its entirety herein by reference.

### FIELD OF THE INVENTION

This invention relates generally to online solicitation of donations, and more particularly, to systems for managing, soliciting, and allowing online shoppers to donate to selected charitable or nonprofit organizations.

### BACKGROUND OF THE INVENTION

Various attempts at soliciting donations online have been made. One attempt by Campus Crusade for Christ International, a worldwide, interdenominational Christian ministry, allows online shoppers to donate during checkout to the Campus Crusade for Christ International by inputting an amount to donate or checking a box to round up the total to the “Next $1.00”, “Next $5.00”, or “Next $10.00.”

Earth's Own Gifts website, an on-line retailer, has a shopping cart which allows an online shopper to select from one of a six charities for donation of a portion of the company's profits.

U.S. Patent Application Publication No. 2002/0111904, by Gruber et al., discloses a method for soliciting a charitable donation for an organization from online shoppers during electronic commerce which includes the steps of hosting a website having information about a fundraising campaign for an organization, one or more electronic catalogs listing one or more items or events that are available for purchase by the online shoppers through the hosted web site. Upon checkout, information regarding one or more charities is provided along with a suggested amount for donation.

U.S. Pat. No. 5,555,497, issued to Helbling, discloses a centralized accounting and collection system for charitable contributions made at respective vending establishments and capable of communicating to a number of charitable institutions which may subscribe to the central station installation the results of such collections so as to enable the charitable institutions to receive payments directly from the central station or from the vending establishments based on an accounting provided by the central station. The system includes a plurality of machines that are remotely located and includes modems for telecommunications with a central station. The machine has a keyboard enabling a particular charity to be selected from a number of charities displayed on a monitor controlled from the central station. In addition, the amount of money to be contributed can be selected via a keyboard, generally in increments of a specific sum, e.g., $1.00.

There is a need for further improvements in online solicitations of donations.

### SUMMARY OF THE INVENTION

The present invention provides, in a first aspect, a system for managing donations made during checkout of a plurality of online purchases at a plurality of online retailers by a plurality of online shoppers. The system includes a processor for receiving, over a communications network, data regarding a plurality of amounts for donation and a plurality of selected organizations made during checkout of the plurality of online purchases at the plurality of online retailers by the plurality of online shoppers, means for collecting a plurality of payments for the plurality of amounts for donation, and means for distributing the plurality of payments among the plurality of organizations based on the data.

The present invention provides, in a second aspect, a system for use in soliciting donations during checkout of a plurality of online purchases at a plurality of online retailers by a plurality of online shoppers. The system includes a processor operable to display on a display an amount for donation to an online shopper during checkout of an online purchase. The processor is also operable to display on the display a plurality of organizations from which the online shopper can choose to donate the amount, and to provide the online shopper with the ability to select at least one of the displayed plurality of organizations in which to donate the amount. The processor is further operable to transmit, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.

The present invention provides, in a third aspect, at least one program storage device readable by a machine embodying at least one program of instructions executable by the machine to perform a method for use in soliciting donations. The method includes displaying to an online shopper an amount for donation during checkout of an online purchase at an online retailer, displaying to the online shopper a plurality of organizations from which to donate the amount, providing the online shopper with the ability to select at least one of the displayed plurality of organizations in which to donate the amount, and transmitting, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.

The present invention provides, in a fourth aspect, a system for warehousing information regarding a plurality of donations made during checkout of a plurality of online purchases at a plurality of online retailers by a plurality of online shoppers. The system includes means for storing data regarding the plurality of donations comprising indicia identifying a donation, an amount of the donation, identify of at least one organization selected by the online shopper for receipt of the donation, contact information for the online shopper, identity of an online retailer to which the online shopper made the donation, and a date of the donation.

The present invention provides, in a fifth aspect, a system for use in soliciting donations during checkout of a plurality of online purchases at a plurality of online retailers by a plurality of online shoppers. The system includes a processor operable to display on a display to an online shopper an inquiry to donate during checkout of an online purchase at an online retailer, provide the online shopper with the ability to enter an amount for donation, display on the display a plurality of organizations from which the online shopper can choose to donate the amount, and provide the online shopper with the ability to select at least one of the displayed plurality of organizations in which to donate the amount. The processor is also operable to transmit, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and accompanying drawings in which:

FIG. 1 is a diagrammatic illustration of a networked donation management system in accordance with the present invention connected via a communications network to a plurality of online shopper terminals, a plurality of online retailer terminals, and a plurality of charitable or nonprofit organization terminals;

FIG. 2 is one embodiment of a screen display for the online shopper terminals of FIG. 1 integrated with an online purchase order for soliciting a donation during checkout at an online retailer;

FIG. 3 is one embodiment of a screen display for the online shopper terminals of FIG. 1 illustrating the purchased items, the donation amount, and the order total;

FIG. 4 another embodiment of a screen display for the online shopper terminals of FIG. 1 for soliciting a donation during checkout of an online purchase at an online retailer;

FIG. 5 is a diagrammatic illustration of one embodiment of the flow of some of the data and funds among the plurality of online shoppers, the plurality of online retailers, the plurality of charitable or nonprofit organizations, and the networked donation management system of FIG. 1;

FIG. 6 is a diagrammatic illustration of another embodiment of a networked donation management system in accordance with the present invention;

FIG. 7 is a flowchart of a method for use in soliciting donations online in accordance with the present invention;

FIG. 8 is a flowchart of a method for managing donations in accordance with the present invention;

FIG. 9 is a flowchart of another method for use in soliciting donations online in accordance with the present invention; and

FIG. 10 is a flowchart of a method for use in making donations online in accordance with the present invention.

### DETAILED DESCRIPTION OF THE INVENTION

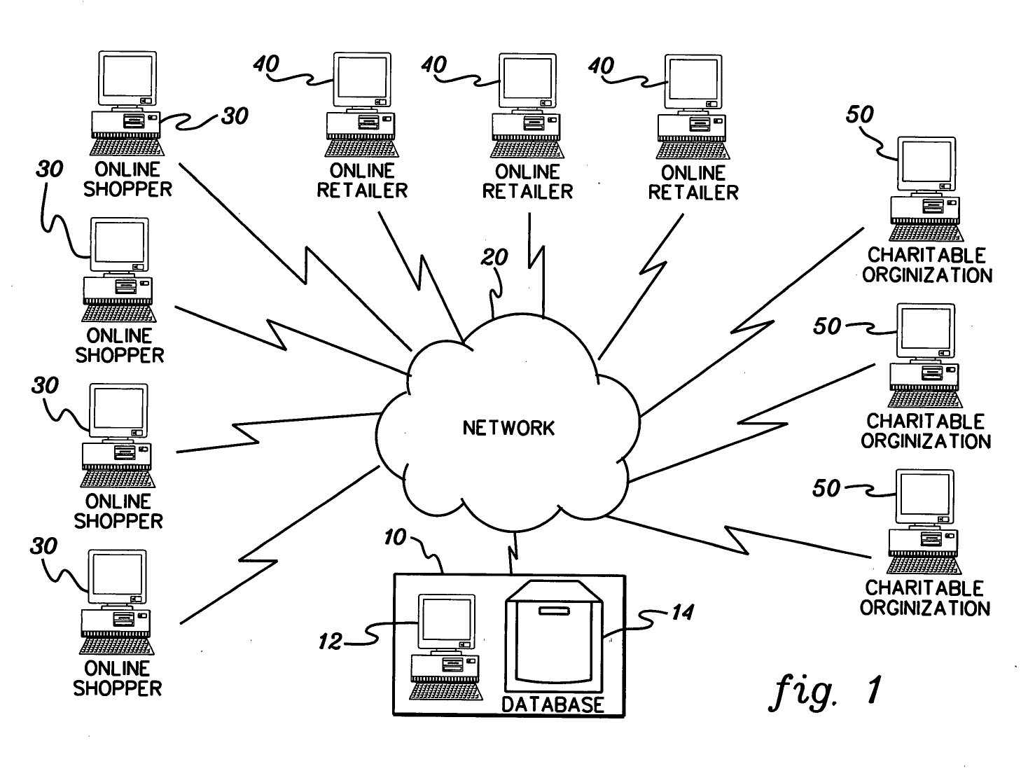

FIG. 1 is an example of one embodiment of a networked donation management system 10 in accordance with the present invention, which may be operated by a business enterprise, for managing donations to organizations such as charitable or nonprofit organizations. As described in greater detail below, in one aspect, online shoppers are provided with a suggested amount in which to donate during checkout of online purchases from online retailers and provided with a list of charitable or nonprofit organizations in which to donate the suggested donation amount or other donation amount. Another aspect of the present invention is the integration of the collection of data regarding the solicitation and authorization of donations from a plurality of online shoppers making purchases at a plurality of online retailer websites. Still another aspect of the present invention is the integration of the collection of funds regarding the solicitation and authorization of donations from a plurality of online shoppers making purchases at a plurality of online retailer websites and the distribution and allocation of the funds to the designated charitable or nonprofit organizations. Online retailers may include online retailers offering the sale of products and/or services for purchase. The online retailers include online retailers hosted by different entities.

As shown in FIG. 1, generally networked donation management system 10 includes a terminal 12 connected to a data storage unit 14. Networked donation management system 10 is connectable to a network 20 such as a global network, the Internet, or other network for communication with a plurality of online shopper terminals 30, a plurality of online retailer terminals 40, and a plurality of charitable or nonprofit organization terminals 50. The various terminals may include an input/output device, a memory, and a processor. For example, the networked donation management system terminal 12 may include a server, the online shopper terminals may include personal computers, personal digital assistants, or other devices, and the charitable or nonprofit organization terminals may include servers or personal computers. The various terminals may be operably connected or linked as described in greater detail below.

Such a donation technique provides a generally easy way to solicit donations, and allows online shoppers to readily donate to their favorite charitable or nonprofit organizations from among a list of organizations. For example, the online shoppers may be asked at checkout if they would like to round-up their total purchase price to the nearest dollar and donate the spare change to one or more charitable or nonprofit organizations. The online shoppers can also designate a different dollar amount to donate. While each donation will likely be small, when aggregated, the total of these amounts may be significant. By inserting the donation decision into the checkout process, the effort and time required to make a donation is reduced. For example, the online shoppers will already have entered credit card information and are already confident in the site's security. The online shoppers may simply be required to check a box to quickly and easily donate a small amount of money.

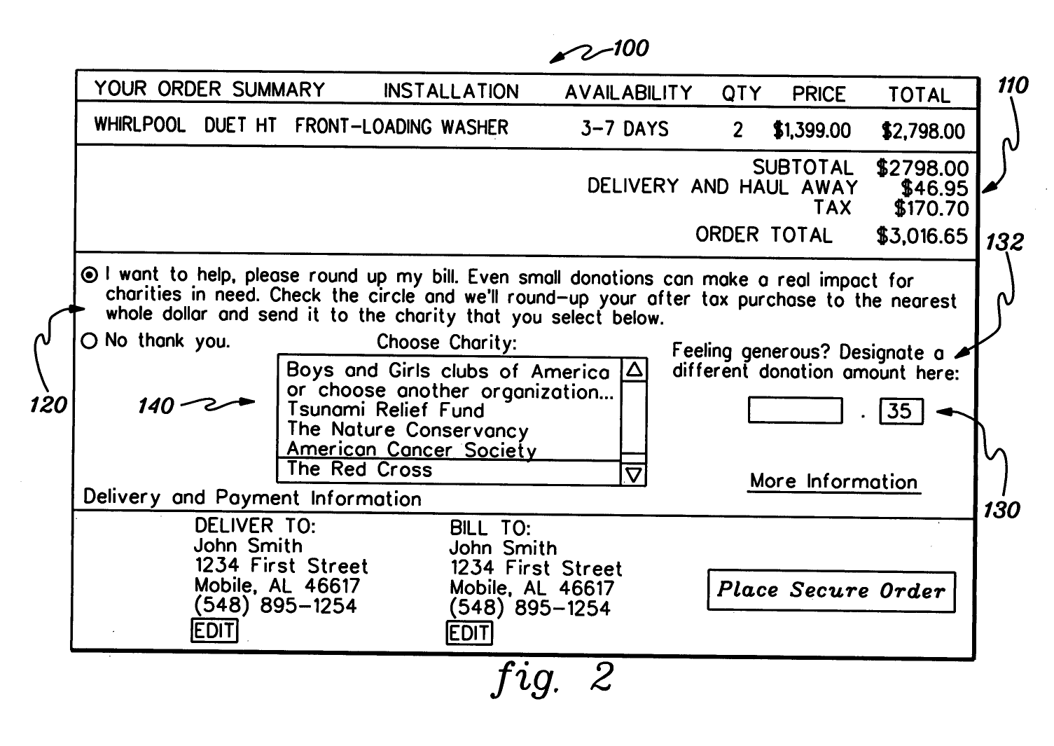

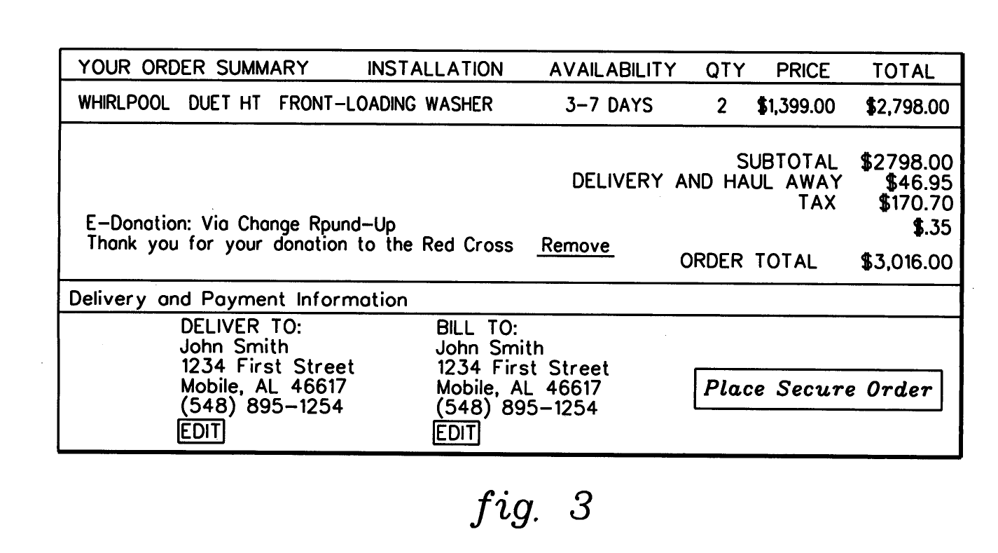

FIG. 2 illustrates one embodiment of a screen display 100 for display on terminals 30 (FIG. 1) for soliciting a donation from online shoppers during checkout. In the upper portion 110 of the illustrated screen display 100, one or more items to be purchased online may be listed and the total purchase amount indicated. A middle portion 120 of the display may include an inquiry to the online shopper regarding making a donation. An inquiry may require the online shopper to simply authorize the making of a donation or decline from making a donation. For example, an online shopper may be required to click on one of the two options. A suggested amount of a donation is provided in a data entry field 130. For example, during checkout, a rounded-up amount, the difference between the amount of the total purchase and the next whole dollar amount may be calculated, and displayed in data entry field 130. The online shopper may also be encouraged to donate a larger amount by an inquiry 132 displayed above data entry field 130. A display 140 may also include a listing of a plurality of organizations such as charitable or nonprofit organizations from which the online shoppers can select. The list of organizations may include a scroll down or dropdown menu. An online shopper may simply click on a desired organization to highlight the organization. For donating to more than one organization, the online shopper may hold down the “CONTROL” key while moving the curser and clicking and highlighting the desired organizations in which to donate. Where more than one organizations is selected, the donation may be apportioned between or among the various organizations selected. Thereafter, the online shopper continues with the checkout of the order. The online shopper's contact information, credit card information usually having already been entered. FIG. 3 illustrates the purchase order and authorized donation which is ready for confirmation of the order.

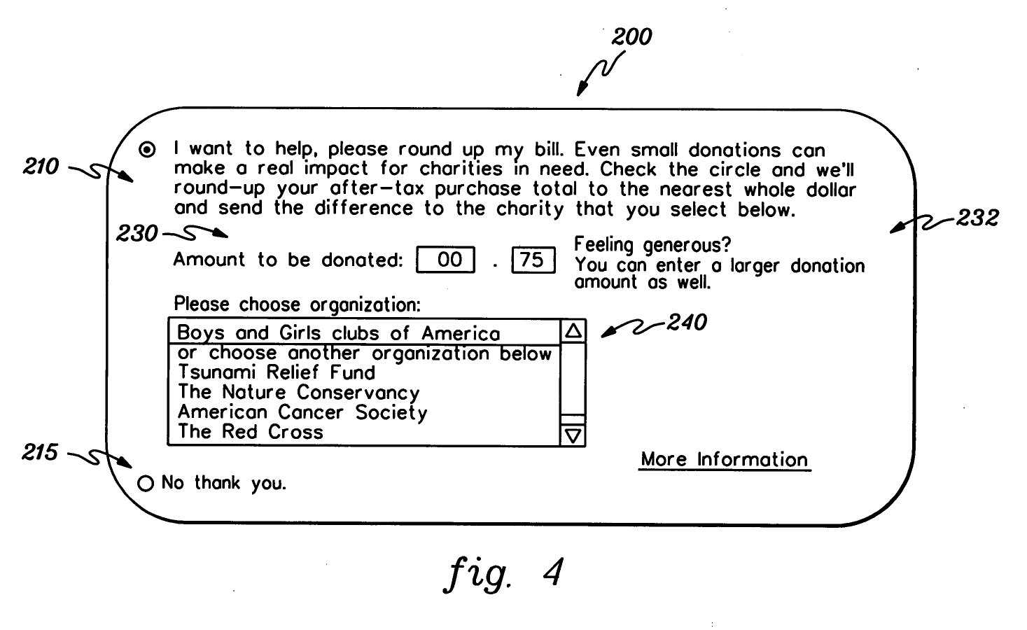

FIG. 4 illustrates an embodiment of a stand-alone screen display 200 for an online shopper terminal for soliciting a donation during checkout of an online purchase. The upper portion 210 of the illustrated screen display 200 may include an inquiry to the online shopper regarding making a donation. An inquiry may require the online shopper to simply authorize the making of a donation by clicking the circle and upon doing so the circle is highlighted with a solid dot. Lower portion 215 of screen display 200 allows the online shopper to decline from making a donation by clicking the circle. A suggested amount of a donation may be provided in a data entry field 230. For example, during checkout, a rounded-up amount, the difference between the amount of a purchase order and the next whole dollar amount may be calculated, and displayed in data entry field 230. The online shopper may also be encouraged to donate a larger amount by an inquiry 232 displayed along side data entry field 230. A display 240 may also include a listing of a plurality of organizations such as charitable or nonprofit organizations from which the online shoppers can select. The list of organizations may include a scroll down or dropdown menu. An online shopper may simply click on the desired organization to highlight the organization. For donating to more than one organization, the shopper may hold down the “CONTROL” key while moving the curser and clicking and highlighting the desired organizations in which to donate.

In other embodiment of the solicitation of donations technique, the suggested amount for donation may be the difference to the nearest five dollars, nearest ten dollars, etc. For example, if a purchase amount is $179, the suggested amount may be $21. The suggested amount may be a non-rounded up number such as 50 cents, one dollar, two dollars, five dollars, ten dollars, etc. In addition, the suggested amount may be a randomly generated number. The randomly generated number may be between an upper limit and a lower limit or based on a percentage of the total sale of the online purchase. While the present invention is described in connection with a currency identified as dollars, it will be appreciated that where another currency is used for the purchase online, the suggested amount may be to an appropriate currency amount, e.g., to the next Euro, next Pound, next 100 Yen, etc. Alternatively, an amount may not be selected, but instead, an inquiry may be made to the online shopper to input an amount to donate.

The solicitation of donations technique of the present invention may be implemented by custom integration in an online retailer's checkout program or by a software plug-in which works with an online retailer's checkout program.

Custom integration of the solicitation of donations technique of the present invention in an online retailers shopping cart may be performed by either the retailer's technical staff or by outside consultants. In this case, the online retailer's shopping cart presents and calculates the rounded-up amount. If the online shopper agrees to the suggested or rounded-up amount and makes a donation, the required customer information and donation amount is encrypted and securely transmitted to the networked donation management system 10 using a method such as pre-specified extensible mark-up language (XML) data format as described in greater detail below. Another option may be to transmit the information as a file such as a CSV (Comma Separated Variable) data file or other file. Once this information is received by networked donation management system 10, it may be verified and stored. Shopping cart vendors, for example, companies that sell pre-packaged shopping cart systems for online retailers, may hard code the solicitation of donation technique into the product and the online retailers may simply activate the solicitation of donation feature.

The solicitation of donations technique of the present invention may also be implemented by an easy-to-use shopping cart plug-in software program. The online retailer may allocate a specified amount of space (e.g. dimensions measured in pixels) in its shopping cart to the solicitation of donations feature. For example, the actual text and checkboxes used to present the suggested or rounded-up option to the shopper may be provided in real-time from networked donation management system 10, but presented on the retailer's shopping cart as a very small webpage within a webpage. In addition, the amount of the round-up may be calculated by the plug-in software program or sent from networked donation management system 10 to the online retailer to be displayed in the shopping cart. If the online shopper makes a donation, this information is sent to networked donation management system 10 using the XML specifications as described above.

It will be appreciated that other ways of incorporating the solicitation of donations technique of the present invention into the checkout of online purchases may be suitably employed. For example, each online retailer may customize the various messages to promote specific charities or nonprofit organizations or themselves as benevolent supporters. The charitable and nonprofit organizations may also have the option when initially setting up the solicitation of donations technique to approve online retailers prior to implementation and/or disallow certain online retailers.

With reference again to FIG. 1, one aspect of the present invention is the transfer of data from the online retailers to networked donation management system 10 and to the charitable and nonprofit organizations. The data regarding the donation may include a donation amount, one or more selected organizations, a date, and a time. Data regarding the online shopper may include the online shopper's first name, last name, a mailing address, a telephone number, and an e-mail address. Data regarding the online retailer may include the name of the online retailer and order code or number. Additional information may also include, the total purchase amount, number of exposures, drop-off rates, and other information regarding the donations. In addition, networked donation management system 10 may also serve as the hub for e-mail communication with the online shopper donors.

The data may be forwarded in real-time from the online retailer to networked donation management system 10 or stored as a batch and periodically forwarded to networked donation management system 10. It will also be appreciated that the online shopper terminal may forward the data regarding the donation to the networked donation management system 10.

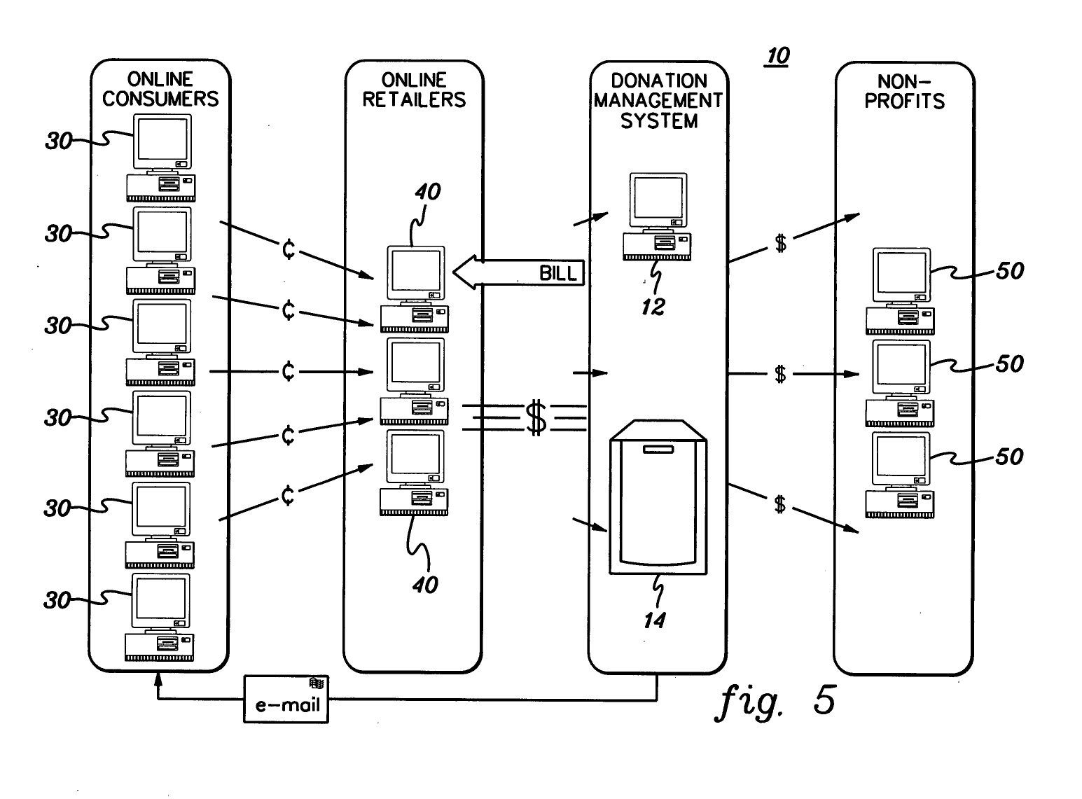

With reference to FIG. 5, another aspect of the present invention is the collection and distribution of the donations to the various selected organizations. For example, the flow of funds may include the online shoppers paying the online retailers via a credit card for their purchase of products and the donation, the online retailers collecting the donations from the online shoppers, networked donation management system 10 billing the online retailers, the online retailers forwarding the donated funds to networked donation management system 10, and networked donation management system 10 collecting and distributing the donations to the appropriate organizations or to their financial banking accounts. As the transfer of funds may be electronic, the billing, collection, and distribution may be automated. A commission such as for the online retailer and for the operator of the networked donation system may be charged, as agreed with the organizations, prior to the distribution of the funds to the organizations of the donations less the commission. The financial transactions may use accounts that are audited and bonded to insure integrity. Billing may occur periodically such as monthly, or the online retailers may simply forward the data and funds regarding the donations to networked donation system 10 periodically without the need for periodic billing. Billing may also not be necessary where a credit card is billed twice, once for the merchandise and once for the donation. In this case, networked donation management system 10 collects directly from the credit card companies and then distributes the donations to the charitable and nonprofit organizations. Another option may be for the online retailers to pay the charitable or nonprofit organizations directly while networked donation management system 10 manages the data and confirms the donations. By managing the reporting, billing, collection and disbursement of funds, the networked donation management system provides a valuable service of creating auditing and accountability to the online donation collection process.

With reference again to FIG. 1, networked donation management system 10 may support a website which describes the services and informs charitable and nonprofit organizations, online retailers, and online shoppers of the donation technique of the present invention and how to join the networked donation management system.

Another feature of networked donation management system 10 may include sending confirmation of the donation to an online shopper. For example, once the donation information is received by networked donation management system 10, an electronic receipt may be sent via e-mail to the donor online shopper. The e-mail communication provides the benefit of confirming the donor's contribution for tax purposes. Additionally, it offers another opportunity for the retailer and the benefiting charitable or nonprofit organizations to reach out to the donor.

Still another feature of networked donation management system 10 may include providing the charitable and nonprofit organizations with website access via a unique username and password. Once an organization logs in to their account, they can view donation data for their organization in real-time. In the case of a nonprofit organization, they may be able to view and sort the donations by online retailers from which they are receiving donations. The information can be viewed online, or downloaded in a file that can be opened in a spreadsheet program. In addition, the organizations may request that donation reports be e-mailed to them on a regular basis.

The networked donation management system of the present invention may incorporate other features as well. For example, the networked donation management system may provide solicitation and collection of donations directly on behalf of charitable or nonprofit organizations. For example, the organizations may provide a link for online users of their website to access the networked donation management system. Alternatively, the organizations website may provide for the solicitation of donations to the organization, and the data regarding the donation then forwarded to the networked donation management system for processing and collection.

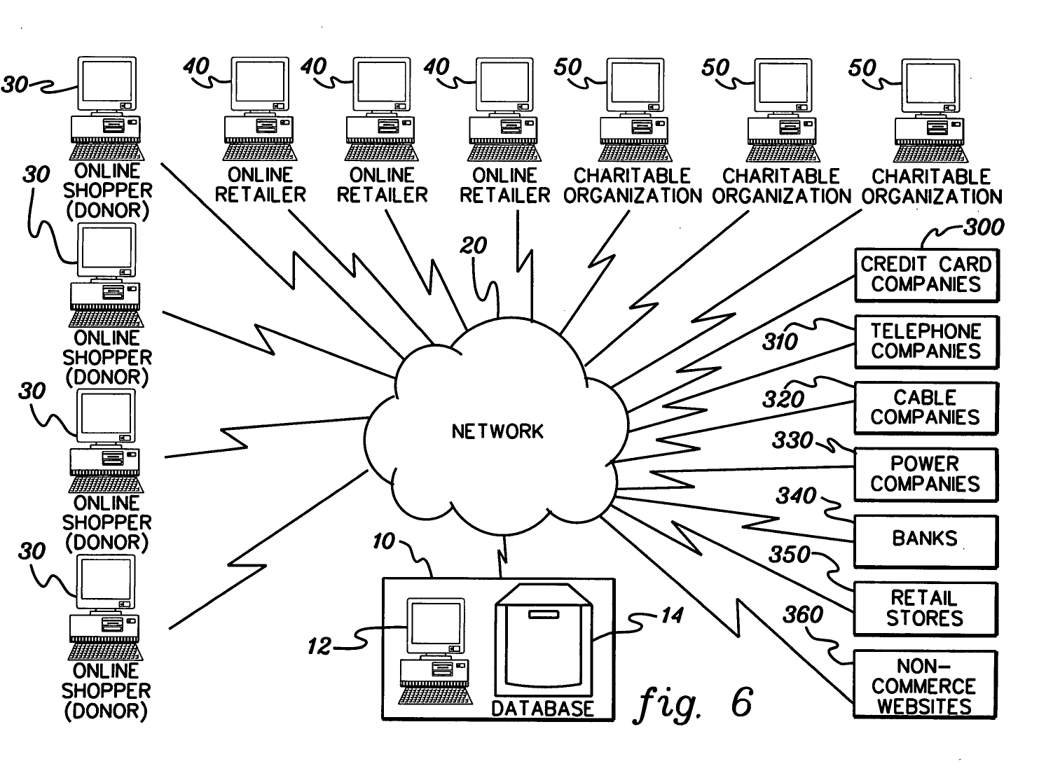

FIG. 6 illustrates another implementation of the present invention for soliciting donations. Networked donation management system 10 may also be integrated with credit card companies 300 to offer a credit/debit card that automatically rounds-up purchase prices to the nearest dollar or to a pre-set limit. In addition, companies which issue recurring bills such as telephone companies 310, cable television companies 320, power companies 330, etc., may have a customer's profile so that every time they make a purchase or pay a bill, there is a round-up involved. Banks 340 may be linked to the system for providing donations when a bill is paid using a checking account. Companies that offer rebates or rewards may allow their customers to donate or designate a portion or their entire rebate to one or more organizations. Networked donation management system 10 may also be configured to integrate with a plurality of retail stores 350 during point-of-sales transactions. It will also be appreciated that the online retailers may include websites that provide other services such as providing information while also allowing of the purchase of products. In addition, networked donation management system 10 may also be implemented with non-commerce websites 360 such as highly trafficked websites that do not sell products to enable solicitation of donations. The data and the funds can be transmitted to the networked donation management system for distribution.

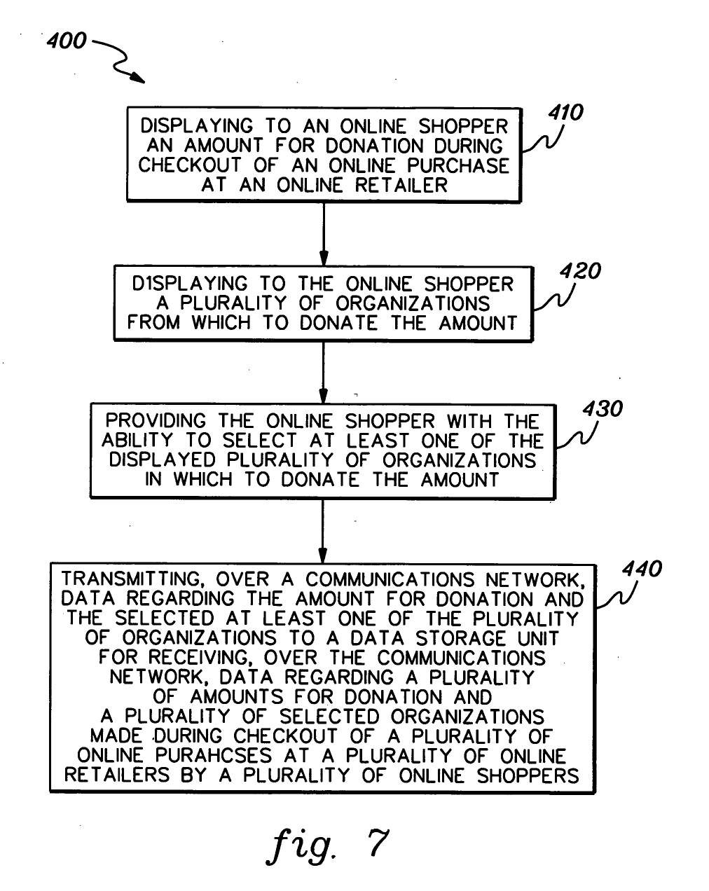

With reference to FIG. 7, FIG. 7 illustrates a flowchart of a method 400 for use in soliciting donations online. Method 400 includes at 410, displaying to an online shopper an amount for donation during checkout of an online purchase at an online retailer, and at 420, displaying to the online shopper a plurality of organizations from which to donate the amount, at 430, providing the online shopper with the ability to select at least one of the displayed plurality of organizations in which to donate the amount, and at 440, transmitting, over a communications network, data regarding the amount for donation and the selected at least one of the plurality of organizations to a data storage unit for receiving, over the communications network, data regarding a plurality of amounts for donation and a plurality of selected organizations made during checkout of a plurality of online purchases at a plurality of online retailers by a plurality of online shoppers.

Method 400 may further include determining the amount as the difference between a price of the online purchase and a higher amount, such as a rounded-up amount between the price of the online purchase and a dollar amount such as to the next nearest dollar amount, the next nearest five dollar amount, the next nearest ten dollar amount, and the next nearest twenty dollar amount. The online shopper may be allowed to change the amount to a different amount.

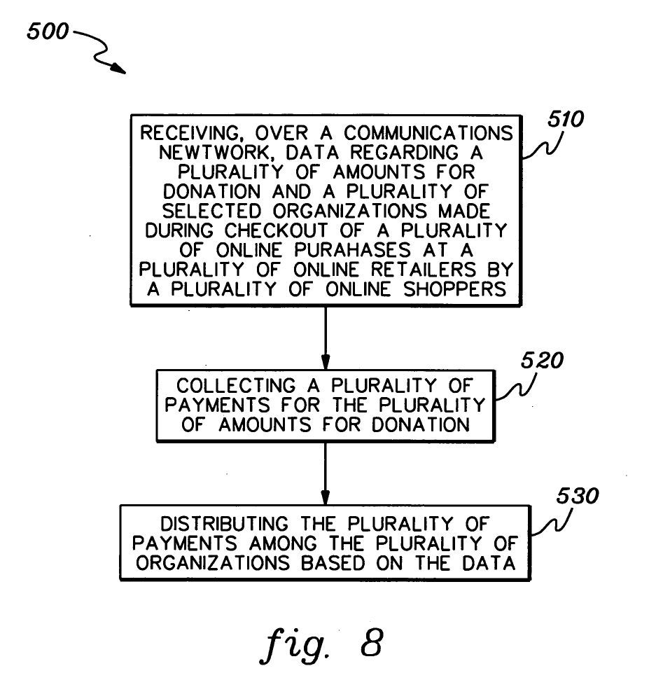

FIG. 8 illustrates a flowchart of a method 500 for managing donations. Method 500 includes, at 510, receiving data, over a communications network, transmitting, over a communications network, data regarding a plurality of amounts for donation and a plurality of selected organizations made during checkout of a plurality of online purchases at a plurality of online retailers by a plurality of online shoppers, at 520, collecting a plurality of payments for the plurality of amounts for donations, and at 530, distributing the plurality of payments among the plurality of organizations based on the data.

Method 500 may also include billing the plurality of online retailers for an amount based on the data. The collecting a plurality of payments may include collecting a plurality of payments from a plurality of credit card companies. The method may further include, providing access to the plurality of organizations, the plurality of online retailers, and the plurality of online shoppers to view data regarding the donations.

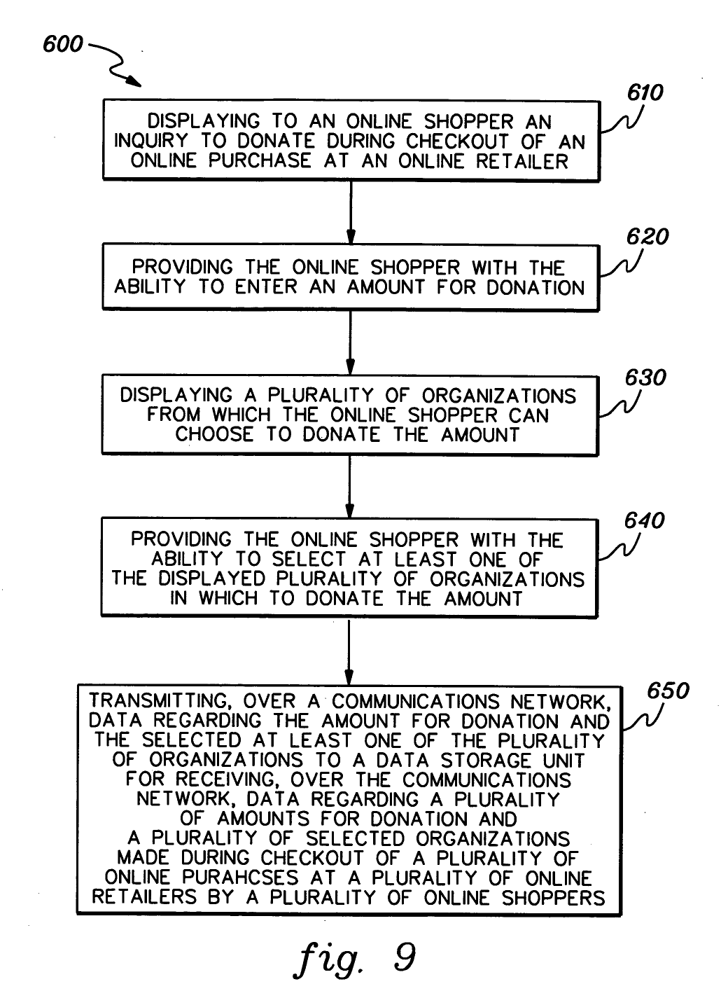

FIG. 9 illustrates a flowchart of another method 600 for use in soliciting donations online. Method 600 includes at 610, displaying to an online shopper an inquiry to donate during checkout of an online purchase at an online retailer, at 610, providing the online shopper with the ability to enter an amount for donation, at 620, displaying a plurality of organizations from which the online shopper can choose to donate the amount, at 630, providing the online shopper with the ability to select at least one of the displayed plurality of organizations in which to donate the amount, and at 640, transmitting, over a communications network, data regarding the amount for donation and the selected at least one of the plurality of organizations to a data storage unit for receiving, over the communications network, data regarding a plurality of amounts for donation and a plurality of selected organizations made during checkout of a plurality of online purchases at a plurality of online retailers by a plurality of online shoppers.

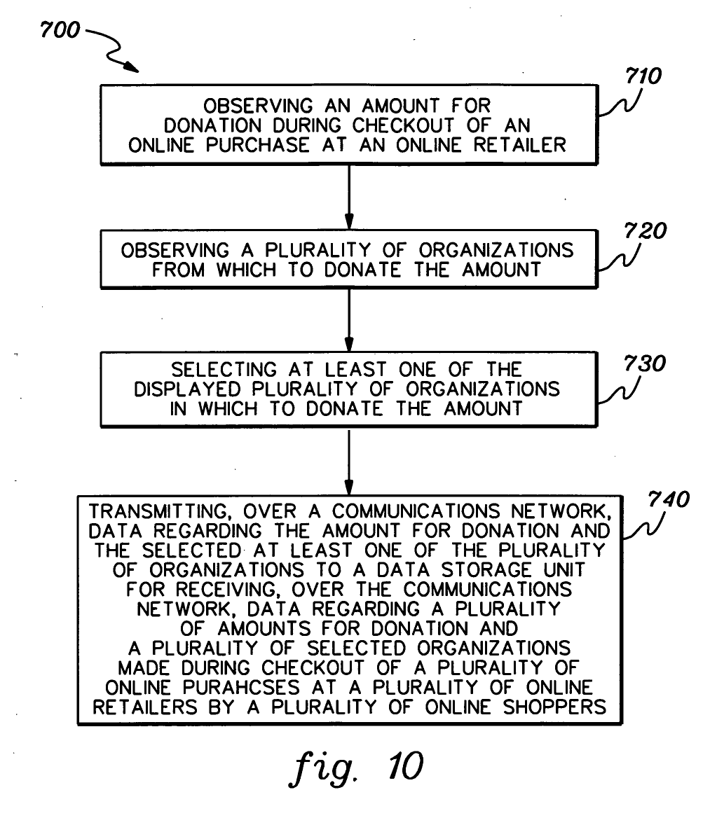

FIG. 10 illustrates a flowchart of a method 700 for use in making donations online. Method 700 includes at 710, observing such as on a computer monitor an amount for donation during checkout of an online purchase at an online retailer, at 720, observing a plurality of organizations from which to donate the amount, at 730, selecting at least one of the displayed plurality of organizations in which to donate the amount, and at 740, transmitting, over a communications network, data regarding the amount for donation and the selected at least one of the plurality of organizations to a data storage unit for receiving, over the communications network, data regarding a plurality of amounts for donation and a plurality of selected organizations made during checkout of a plurality of online purchases at a plurality of online retailers by a plurality of online shoppers.

It will also be appreciated that in the wake of recent disasters, the networked donation management system may allow for updating of the online retailer checkout pages to list organizations that aid in relief efforts for various disasters. Desirably, the networked donation management system may be able to make changes on the online retailer checkout page, and in particular, to the list of organizations in which to donate. In one implementation, the scroll down or dropdown list of organizations may be provided by the networked donation management system. In addition, the online retailer may be able to log into the networked donation management system and customize or change or add organizations that are to appear in the scroll down or drop down menu list of organizations. This will allow retailers to support numerous charitable and nonprofit organizations with one implementation. This will also allow retailers to change the listed charitable and nonprofit organizations based on seasonal needs or to help with specific disaster relief quickly as noted below. This also allows retailers to choose charitable and nonprofit organizations from the networked donation management system that are relevant to their corporate values and customer base.

The networked donation management system may be operable to populate the list of charitable or nonprofit organizations with organizations that the consumer is likely to care about. For example, if the consumer types in an Albany, New York zip code, the scroll down or dropdown list of charitable or nonprofit organizations may include local charitable and nonprofit organizations in the list. In addition, if the online shopper provides a zip code and selects a national charitable or nonprofit organization, the donated amount may be forwarded to the regional branch based on the zip code. The listing of charitable or nonprofit organizations may also be based on the items purchased by the online shopper. For example, if a book about music is being purchased, the networked donation system may include organizations such as Save the Music which the online shopper is likely to support.

The implementation of the networked donation management systems may include reimbursement of costs to online retailers for implementation of the solicitation of donations technique of the present invention. The reimbursement may be provided by the operator of the networked donation management system, not the charitable or nonprofit organization, and may be based on a percentage of the fee received by the operator of the networked donation management system from the organizations.

With reference again to FIG. 1, the terminals may include, for example, one or more central processing units, memory and one or more input/output devices, as is well known in the art. The central processing units may be based, for instance, on a Sun workstation running a Unix operating system, or a personal computer running a Microsoft WINDOWS operating system. The central processing units desirably include or has access to memory or data storage units, e.g., hard drive(s), compact disk(s), tape drive(s), etc., for storing various data which are accessed and used in monitoring the solicitation of donations.

Communications network 20 may comprise a local area network or a global communications network such as the Internet which comprises a vast number of computers and computer networks that are interconnected through communication links. The interconnected computers exchange information using various services, such as electronic mail, and the World Wide Web (WWW). The WWW service allows computing units (i.e., Web server or Web site) to receive information or a web page which can be displayed using a browser on a monitor. A browser is a special-purpose application program that effects the requesting of Web pages and the displaying of Web pages. For example, online shopper terminals 20 may typically uses a browser such as Microsoft INTERNET EXPLORER, Netscape NAVIGATOR, or Mozilla FIREFOX.

More particularly, web pages are typically defined using HyperText Markup Language (HTML). HTML provides a standard set of tags that define how a Web page is to be displayed. For example, the various tags control the displaying of text, graphics, controls, and other features. When the requested HTML document is received, the browser displays the Web page as defined by the HTML document.

The above-described computing environments are only offered as examples. The present invention can be incorporated and used with many types of computing units, computers, processors, nodes, systems, workstations and/or environments.

While various embodiments of the present invention have been illustrated and described, it will be appreciated by those skilled in the art that many further changes and modifications may be made thereunto without departing from the spirit and scope of the invention.

1. A system for managing donations made during checkout of a plurality of online purchases at a plurality of online retailers by a plurality of online shoppers, the system comprising:
means for receiving, over a communications network, data regarding a plurality of amounts for donation and a plurality of selected organizations made during checkout of the plurality of online purchases at the plurality of online retailers by the plurality of online shoppers;
means for collecting a plurality of payments for the plurality of amounts for donation; and
means for distributing the plurality of payments among the plurality of organizations based on the data.

2. The system of claim 1 wherein the data regarding the plurality of amounts for donation are based on a plurality of suggested amounts for donation.

3. The system of claim 1 wherein the data regarding the plurality of amounts for donation are based on a plurality of rounded-up amounts corresponding to the difference between a price of the online purchase and a dollar amount.

4. The system of claim 1 further comprising means for storing in a data storage unit the data regarding a plurality of amounts for donation and a plurality of selected organizations.

5. The system of claim 1 further comprising means for billing the plurality of online retailers based on the data.

6. The system of claim 1 wherein the means for collecting comprises means for receiving a plurality of payments from the plurality of online retailers.

7. The system of claim 1 wherein the means for collecting comprises means for receiving a plurality of payments from a plurality of credit card companies.

8. The system of claim 1 wherein the means for receiving data comprises at least one of means for receiving the data in real-time from the plurality of online retailers. and means for receiving the data periodically over time.

9. The system of claim 1 further comprising means for sending a plurality of receipts regarding the plurality of donations to the plurality of online shoppers.

10. The system of claim 1 further comprising means for providing a summary of past donations to the plurality of online shoppers.

11. The system of claim 1 further comprising means for providing access to the plurality of organizations to view data regarding the plurality of donations.

12. The system of claim 1 further comprising at least one of means for providing access to the plurality of online retailers to view data regarding the plurality of donations and means for providing access to the plurality of online shoppers to view data regarding the plurality of donations.

13. A system for use in soliciting donations during checkout of a plurality of online purchases at a plurality of online retailers by a plurality of online shoppers, the system comprising:
a processor operable to display on a display an amount for donation to an online shopper during checkout of an online purchase;
the processor operable to display on the display a plurality of organizations from which the online shopper can choose to donate the amount;
the processor operable to provide the online shopper with the ability to select at least one of the displayed plurality of organizations in which to donate the amount; and
the processor operable to transmit, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.

14. The system of claim 13 further comprising the processor operable to determine the amount as the difference between a price of an online purchase and a higher amount, and wherein the processor is operable to display the amount for donation as the difference.

15. The system of claim 13 further comprising the processor operable to determine the amount as a rounded-up amount between a price of an online purchase and a dollar amount, and wherein the processor is operable to display the amount for donation as the rounded-up amount.

16. The system of claim 15 wherein the processor operable to determine the rounded-up amount as the amount between the price of the purchase and at least one of a next nearest dollar amount, a next nearest five dollar amount, a next nearest ten dollar amount, and a next nearest twenty dollar amount.

17. The system of claim 13 further comprising the processor operable to allowing the online shopper to change the amount to a different amount.

18. The system of claim 13 wherein the system is implemented in a checkout program of an online retailer.

19. The system of claim 13 wherein the system is implemented in a centralized computing unit in communication via a network with a checkout program of an online retailer.

20. The system of claim 13 wherein the processor operable to display the plurality of organizations based on the location of the online shopper.

21. The system of claim 13 wherein the processor operable to transmit data comprising indicia identifying the donation, an amount of the donation, an identity of the at least one organization selected by the online shopper for receipt of the donation, contact information for the online shopper, identity of the online retailer, and a date of the donation.

22. The system of claim 13 further comprising the processor operable to allow the online shopper to obtain a summary of past donations.

23. At least one program storage device readable by a machine embodying at least one program of instructions executable by the machine to perform a method for use in soliciting donations, the system comprising:
displaying to an online shopper an amount for donation during checkout of an online purchase at an online retailer;
displaying to the online shopper a plurality of organizations from which to donate the amount;
providing the online shopper with the ability to select at least one of the displayed plurality of organizations in which to donate the amount; and
transmitting, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.

24. The at least one program storage device of claim 23 further comprising determining the amount as the difference between a price of the online purchase and a higher amount.

25. The at least one program storage device of claim 23 further comprising determining the amount as a rounded-up amount between a price of the online purchase and a dollar amount.

26. The at least one program storage device of claim 23 wherein the determining the rounded-up amount comprises determining the amount between the price of the purchase and at least one of a next nearest dollar amount, a next nearest five dollar amount, a next nearest ten dollar amount, and a next nearest twenty dollar amount.

27. The at least one program storage device of claim 23 further comprising allowing the online shopper to change the amount to a different amount.

28. The at least one program storage device of claim 23 wherein the transmitting comprises transmitting data regarding indicia identifying the donation, an amount of the donation, an identity of the at least one organization selected by the online shopper for receipt of the donation, contact information for the online shopper, identity of the online retailer, and a date of the donation.

29. The at least one program storage device of claim 23 further comprising providing the online shopper with the ability to authorize the donation amount.

30. The at least one program storage device of claim 23 wherein the transmitting data comprises transmitting data regarding a selected at least two of the plurality of organizations in which to donate the amount.

31. The at least one program storage device of claim 23 wherein the displaying a plurality of organizations comprises displaying the plurality of organizations based on the location of the online shopper.

32. The at least one program storage device of claim 23 further comprising sending an email receipt of the donation to the online shopper.

33. The at least one program storage device of claim 23 further comprising allowing the online shopper to obtain a summary of past donations.

34. A system for warehousing information regarding a plurality of donations made during checkout of a plurality of online purchases at a plurality of online retailers by a plurality of online shoppers, the system comprising:
means for storing data regarding the plurality of donations comprising indicia identifying a donation, an amount of the donation, identify of at least one organization selected by the online shopper for receipt of the donation, contact information for the online shopper, identity of an online retailer to which the online shopper made the donation, and a date of the donation.

35. The system of claim 34 wherein the contact information comprises the online shopper's e-mail address.

36. The system of claim 34 further comprising means for providing access to the data storage unit to the plurality of organizations to view data regarding donations.

37. The system of claim 34 further comprising providing means for access to the data storage unit to the plurality of online retailers to view data regarding the plurality of donations.

38. The system of claim 34 further comprising means for providing access to the data storage unit to the plurality of online shoppers to view data regarding the plurality of donations.

39. A system for use in soliciting donations during checkout of a plurality of online purchases at a plurality of online retailers by a plurality of online shoppers, the system comprising:
a processor operable to display on a display to an online shopper an inquiry to donate during checkout of an online purchase at an online retailer;
the processor operable to provide the online shopper with the ability to enter an amount for donation;
the processor operable to display on the display a plurality of organizations from which the online shopper can choose to donate the amount;
the processor operable to provide the online shopper with the ability to select at least one of the displayed plurality of organizations in which to donate the amount; and
the processor operable to transmit, over a communications network, data regarding the amount for donation and the selected at least one of the plurality of organizations to a data storage unit for receiving, over the communications network, data regarding a plurality of amounts for donation and a plurality of selected organizations made during checkout of the plurality of online purchases at the plurality of online retailers by the plurality of online shoppers.
